(19) United States
(12) Patent Application Publication
(10) Pub. No.: US 2010/0095689 A1
(43) Pub. Date: Apr. 22, 2010

(54) VEHICLE AIR CONDITIONER AND METHOD FOR CONTROLLING THE SAME

(75) Inventors: Katsunari Shiroyama, Aichi (JP); Shiro Matsubara, Aichi (JP); Hideaki Tatenoi, Aichi (JP); Masahiro Nakayama, Shizuoka (JP); Mituru Murakami, Shizuoka (JP); Hajime Utiyama, Shizuoka (JP); Yorisada Kondo, Shizuoka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: MITSUBISHI HEAVY INDUSTRIES, LTD., Tokyo (JP); SUZUKI MOTOR CORPORATION, Hamamatsu-shi, Shizuoka-ken (JP)

(21) Appl. No.: 12/447,739

(22) PCT Filed: Oct. 10, 2008
(86) PCT No.: PCT/JP2008/068469

§ 371 Date: Dec. 10, 2009

(30) Foreign Application Priority Data
Oct. 18, 2007 (JP) 2007-271469

(51) Int. Cl. B60H 1/32

(52) U.S. Cl. 62/115; 62/228.1

(57) ABSTRACT

A vehicle air conditioner that can increase the range of energy-saving operation by stopping an engine without impairing the air conditioning comfort and a method for controlling the vehicle air conditioner are provided. The vehicle air conditioner includes a compressor (3) that is driven by an engine (2) to compress a refrigerant, a heat radiator (4) that radiates heat from the compressed refrigerant, an expansion valve (5) that decompresses the refrigerant from which the heat is radiated, a heat absorber (6) that makes the decompressed refrigerant absorb heat, an input unit (8) to which selection information about an air-conditioning priority mode and an energy-saving priority mode is input, and a control unit (9) that selects one of a threshold related to the air-conditioning priority mode and a threshold related to the energy-saving priority mode on the basis of at least the selection information input to the input unit (8) and outputs one of an idle-stop permission request, an idle-stop prohibition request, and an idle-stop cancellation request to the engine (2) on the basis of the selected threshold.

### TECHNICAL FIELD

The present invention relates to a vehicle air conditioner and to a method for controlling the same.

### BACKGROUND ART

In recent years, a technology for performing engine idle-stop (referred to as “IS” hereinafter) control in a vehicle equipped with a vehicle air conditioner has been proposed for the purpose of reducing fuel consumption. The term “engine idle-stop control” refers to control for stopping the running of the engine in the case where the engine is idling when the vehicle is stopped, etc.

On the other hand, a vehicle air conditioner performs air conditioning inside the vehicle cabin by receiving a driving force supplied from the engine. Therefore, a problem during the IS mode in which the running of the engine is stopped is that the air conditioning cannot be performed or that the air-conditioning performance is lowered. In consequence, technologies related to IS control has been proposed, in which a controller that controls the vehicle air conditioner outputs a control signal to an engine controlling device on the basis of the air-conditioning state inside the vehicle cabin; specifically, such a control signal includes a request such as an IS permission request for permitting stoppage of the engine operation or an IS prohibition request for prohibiting stoppage of the engine (for example, see Patent Documents 1 and 2).

### Patent Document 1:

Japanese Unexamined Patent Application, Publication No. 2006-199247

### Patent Document 2:

Japanese Unexamined Patent Application, Publication No.

2001-150943

### DISCLOSURE OF INVENTION

In the above-mentioned IS control, an IS permission threshold and an IS prohibition threshold are set for each of predetermined parameters related to the air-conditioning state (e.g., an outside-air temperature, an inside cabin temperature, an evaporator temperature, a target output-air temperature), and IS control is performed on the basis of whether or not each parameter exceeds the corresponding threshold. Moreover, in order to prevent the IS permission request and the IS prohibition request from being output repetitively to the controller and the engine controlling device within a short period of time, a determination hysteresis is set to be relatively large.

However, setting the determination hysteresis to be relatively large in this manner is problematic in that it becomes less easy to switch to the IS prohibition mode once operating in the IS mode. In other words, once in the IS mode, it is not easy to switch to the IS prohibition mode even when the air-conditioning state inside the vehicle cabin becomes unpleasant. This is problematic in that such an unpleasant condition cannot be solved readily.

In order to solve the aforementioned problems, there has been proposed a technology in which a switch is provided for completely prohibiting the IS in response to a request from the vehicle air conditioner.

However, in a method that completely prohibits the IS by means of a switch, depending on the climate and the air-conditioning state, the engine may in some cases be undesirably switched to the IS prohibition mode even when the IS prohibition is not necessary. This becomes a hindrance to the reduction of fuel consumption.

The present invention is intended to solve the aforementioned problems, and an object thereof is to provide a vehicle air conditioner that can increase the range of energy-saving operation by stopping an engine without impairing the air conditioning comfort, as well as a method for controlling the vehicle air conditioner.

In order to achieve the aforementioned object, the present invention provides the following solutions.

A first aspect of the present invention provides a vehicle air conditioner that includes a compressor that is driven by an engine to compress a refrigerant, a heat radiator that radiates heat from the compressed refrigerant, an expansion valve that decompresses the refrigerant from which the heat is radiated, a heat absorber that makes the decompressed refrigerant absorb heat, an input unit to which selection information about an air-conditioning priority mode and an energy-saving priority mode is input, and a control unit that selects one of a threshold related to the air-conditioning priority mode and a threshold related to the energy-saving priority mode on the basis of at least the selection information input to the input unit, and outputs one of an idle-stop permission request, an idle-stop prohibition request, and an idle-stop cancellation request to the engine on the basis of the selected threshold.

According to the first aspect of the present invention, since one of the idle-stop permission request, prohibition request, and cancellation request is output to the engine on the basis of one of the threshold related to the air-conditioning priority mode and the threshold related to the energy-saving priority mode, the idle-stop period of the engine can be extended without impairing the air conditioning comfort.

Specifically, when the air-conditioning priority mode is selected, the threshold related to the air-conditioning priority mode is selected. Consequently, the output timing of the idle-stop permission request, etc. is controlled so that a driving period of the compressor driven by the engine can be ensured, whereby air conditioning inside the vehicle cabin can be properly performed.

On the other hand, when the energy-saving priority mode is selected, the threshold related to the energy-saving priority mode is selected. Consequently, the output timing of the idle-stop permission request, etc. is controlled so as to extend the idle-stop period of the engine, thus increasing the range of energy-saving operation.

The idle-stop permission request is an output related to stopping of idling of the engine when idling. On the other hand, the idle-stop prohibition request is an output related to a prohibition against stopping the operation of the engine that is idling, or in other words, an output related to the continuance of the idling. The idle-stop cancellation request is an output related to starting of idling of the engine when in a stopped state.

In the first aspect of the present invention, it is preferable that a detecting unit that detects a control parameter related to at least one of the engine and the heat absorber be further included, and that the control unit output one of the idle-stop permission request, the idle-stop prohibition request, and the idle-stop cancellation request to the engine on the basis of the selected threshold and the control parameter detected by the detecting unit.

Accordingly, on the basis of the control parameter related to at least one of the engine and the heat absorber, the timing for outputting, for example, the idle-stop permission request to the engine can be controlled more appropriately.

In the above configuration, the control unit preferably outputs the idle-stop permission request to the engine on the basis of an absolute value of the control parameter.

Accordingly, by outputting the idle-stop permission request on the basis of the absolute value of the control parameter, the timing for outputting the idle-stop permission request can be controlled more appropriately.

In the above configuration, the control unit preferably outputs the idle-stop prohibition request or the idle-stop cancellation request to the engine on the basis of an amount of change in the control parameter.

Accordingly, by outputting the idle-stop prohibition request or cancellation request on the basis of the amount of change in the control parameter, the timing for outputting the idle-stop prohibition request or cancellation request can be controlled more appropriately.

Preferably, in the first aspect of the present invention, the control unit outputs the idle-stop prohibition request or the idle-stop cancellation request and is then allowed to output the idle-stop permission request only after elapse of a predetermined time.

Accordingly, in the case where the idle-stop prohibition request or cancellation request is output and the engine continues or starts idling, the idle-stop permission request is output only after elapse of a predetermined period of time. Therefore, the idling of the engine continues at least for the predetermined time. This prevents the idling of the engine from being stopped and started repetitively at short intervals.

A second aspect of the present invention provides a vehicle air conditioner that includes a compressor that is driven by an engine to compress a refrigerant, a heat radiator that radiates heat from the compressed refrigerant, an expansion valve that decompresses the refrigerant from which the heat is radiated, a heat absorber that makes the decompressed refrigerant absorb heat, a detecting unit that detects a control parameter related to at least one of the engine and the heat absorber, and a control unit that outputs an idle-stop cancellation request to the engine on the basis of an amount of change in the detected control parameter occurring from an idle-stop starting point.

According to the second aspect of the present invention, the idle-stop cancellation request is output on the basis of the amount of change in the control parameter occurring from the idle-stop starting point, whereby the timing for outputting the idle-stop cancellation request can be appropriately controlled.

A third aspect of the present invention provides a method for controlling a vehicle air conditioner. The method includes an inputting step for inputting selection information about an air-conditioning priority mode and an energy-saving priority mode, and a controlling step for selecting one of a threshold related to the air-conditioning priority mode and a threshold related to the energy-saving priority mode on the basis of at least the selection information and, on the basis of the selected threshold, outputting one of an idle-stop permission request, an idle-stop prohibition request, and an idle-stop cancellation request to an engine that drives a compressor that compresses a refrigerant.

According to the third aspect of the present invention, since one of the idle-stop permission request, prohibition request, and cancellation request is output to the engine on the basis of one of the threshold related to the air-conditioning priority mode and the threshold related to the energy-saving priority mode, the idle-stop period of the engine can be extended without impairing the air conditioning comfort.

In the vehicle air conditioner according to the first aspect and the second aspect of the present invention and the method for controlling the vehicle air conditioner according to the third aspect of the present invention, one of the idle-stop permission request, prohibition request, and cancellation request is output to the engine on the basis of one of the threshold related to the air-conditioning priority mode and the threshold related to the energy-saving priority mode. This advantageously extends the idle-stop period of the engine and increases the range of energy-saving operation by stopping the engine without impairing the air conditioning comfort.

### BRIEF DESCRIPTION OF DRAWINGS

FIG. 1 is a schematic diagram illustrating the configuration of a vehicle air conditioner according to an embodiment of the present invention.

FIG. 2 is a control block diagram in the vehicle air conditioner in FIG. 1.

FIG. 3 is a diagram illustrating the input status of switches in CASE 1 in Table 1.

FIG. 4 is a diagram illustrating the input status of the switches in CASE 2 in Table 1.

FIG. 5 is a diagram illustrating the input status of the switches in CASE 3 in Table 1.

FIG. 6 is a diagram illustrating the input status of the switches in CASE 4 in Table 1.

FIG. 7 is a diagram illustrating the input status of the switches in CASE 5 in Table 1.

FIG. 8 is a flow chart illustrating the flow of IS control performed by a control unit.

FIG. 9 is a control block diagram used when determining IS prohibition/permission conditions.

FIG. 10 is a schematic diagram illustrating a prohibition condition related to an inside-air temperature.

FIG. 11 is a schematic diagram illustrating a prohibition condition related to an outside-air temperature.

FIG. 12 is a schematic diagram illustrating a prohibition condition related to an evaporator temperature.

FIG. 13 is a schematic diagram illustrating a prohibition condition related to an engine-water temperature.

FIG. 14 is a control block used when determining an IS cancellation condition.

FIG. 15 is a schematic diagram illustrating a cancellation condition related to a target output-air temperature deviation.

FIG. 16 is a schematic diagram illustrating a cancellation condition related to a target inside-air temperature deviation.

FIG. 17 is a schematic diagram illustrating a cancellation condition related to an inside-air temperature deviation.

FIG. 18 is a schematic diagram illustrating a cancellation condition related to the evaporator temperature.

FIG. 19 is a schematic diagram illustrating intake control when an ECON switch is OFF.

FIG. 20 is a schematic diagram illustrating EWP control.

### EXPLANATION OF REFERENCE SIGNS

1: vehicle air conditioner
2: engine
3: compressor
4: condenser (heat radiator)
5: expansion valve
6: evaporator (heat absorber)
8: input panel (input unit)
9: control unit
41: outside-air temperature sensor (detecting unit)
42: evaporator temperature sensor (detecting unit)
43: engine-water temperature sensor (detecting unit)
44: inside-air temperature sensor (detecting unit)
45: A/M-damper degree-of-opening sensor (detecting unit)

### BEST MODE FOR CARRYING OUT THE INVENTION

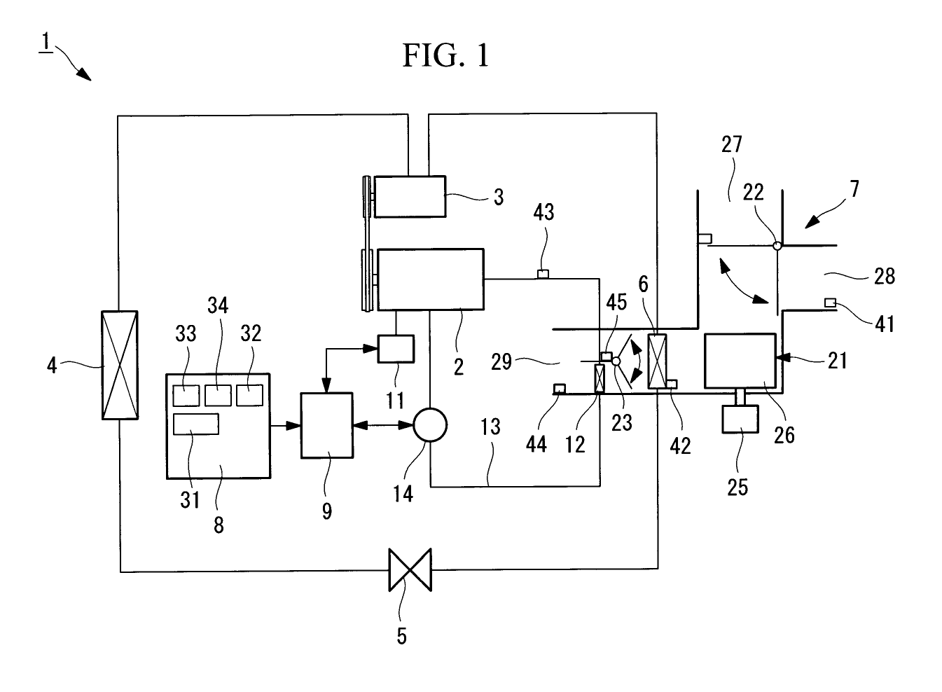

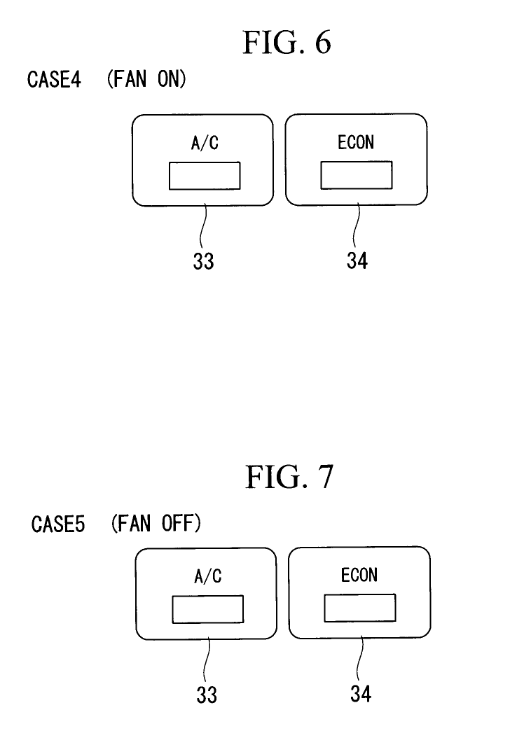

A vehicle air conditioner according to an embodiment of the present invention will be described with reference to FIGS. 1 to 20.

FIG. 1 is a schematic diagram illustrating the configuration of the vehicle air conditioner according to this embodiment.

A vehicle air conditioner 1 according to this embodiment is an air conditioner that controls the temperature of air inside a vehicle cabin to a desired temperature by using a driving force generated by a vehicle engine 2.

As shown in FIG. 1, the vehicle air conditioner 1 is equipped with a compressor 3 driven by the engine 2, a condenser (heat radiator) 4 that condenses compressed refrigerant by making it radiate heat, an expansion valve 5 that decompresses the condensed refrigerant, an evaporator (heat absorber) 6 that evaporates the decompressed refrigerant by making it to absorb heat, an HVAC (heating, ventilating, and air-conditioning) unit 7 containing the evaporator 6 therein, an input panel (input unit) 8 having various kinds of input switches, and a control unit 9 that outputs control signals to the engine 2, the HVAC unit 7, etc.

As shown in FIG. 1, the compressor 3 uses the driving force supplied from the engine 2 to take in and compress the refrigerant evaporated at the evaporator 6, and then discharges the refrigerant towards the condenser 4.

As shown in FIG. 1, the engine 2 is used for running the vehicle, in which the vehicle air conditioner 1 is installed, in addition to driving the compressor 3.

The engine 2 is additionally provided with an engine control unit (referred to as “ECU” hereinafter) 11 that controls the engine 2 and an electric coolant pump (referred to as “EWP” hereinafter) 14 for causing a coolant to circulate, during an IS mode, within a coolant channel 13 in which the coolant can circulate between the engine 2 and a heater core 12 to be described below.

The heater core 12 is a heat exchanger disposed within the HVAC unit 7 and performs heat exchange between the coolant (hot water) and air cooled in the evaporator 6. In other words, the heater core 12 performs heating by making the coolant radiate heat to the cooled air.

The ECU 11 controls the operating mode of the engine 2, e.g., stopping or starting of an idling of the engine 2, on the basis of various information, such as a request output from the control unit 9.

The EWP 14 circulates the coolant between the engine 2 and the heater core 12 so as to transfer the heat of the engine 2 to the heater core 12 in the case where the vehicle air conditioner 1 is to perform a heating operation during the IS mode.

As shown in FIG. 1, the condenser 4 is configured such that high-temperature high-pressure refrigerant discharged from the compressor 3 flows therethrough, and performs heat exchange between the high-temperature high-pressure refrigerant and the outside cabin air. In other words, the condenser 4 condenses the refrigerant by making the refrigerant radiate heat to the outside cabin air.

The expansion valve 5 expands the refrigerant having undergone heat radiation in the condenser 4 so as to decompress the refrigerant.

The evaporator 6 is configured such that the refrigerant decompressed by the expansion valve 5 flows therethrough, and performs heat exchange between the decompressed refrigerant and at least one of the inside cabin air and the outside cabin air. In other words, the evaporator 6 evaporates the refrigerant by making the refrigerant absorb the heat of at least one of the inside cabin air and the outside cabin air.

As shown in FIG. 1, the HVAC unit 7 performs heat exchange between at least one of the evaporator 6 and the heater core 12, which are disposed within the HVAC unit 7, and at least one of the inside cabin air and the outside cabin air so as to control the temperature of the inside cabin air to a desired temperature.

The HVAC unit 7 is provided with a fan 21 that causes air, such as the inside cabin air or the outside cabin air, to flow into the HVAC unit 7 and allows the air to blow into the vehicle cabin, an intake damper 22 that controls the flow rate of inside cabin air and outside cabin air flowing into the HVAC unit 7, and an air mix damper (referred to as “A/M damper” hereinafter) 23 that controls the flow rate of air flowing into the heater core 12. Furthermore, the evaporator 6 and the heater core 12 described above are disposed in the HVAC unit 7.

The fan 21 is disposed between the intake damper 22 and the evaporator 6 and is provided with an impeller 26 that is rotationally driven by a motor 25. The motor 25 and the impeller 26 may be of any known type and are not limited in particular.

The intake damper 22 is a damper disposed between the fan 21 and both an inside-cabin-air intake 27 and an outside-cabin-air intake 28, and controls the flow rate of inside cabin air and outside cabin air that flow into the HVAC unit 7. The intake damper 22 may be any known type of damper and is not limited in particular.

The A/M damper 23 is a damper disposed between the evaporator 6 and the heater core 12 and controls the flow rate of air flowing into the heater core 12. The A/M damper 23 may be any known type of damper and is not limited in particular.

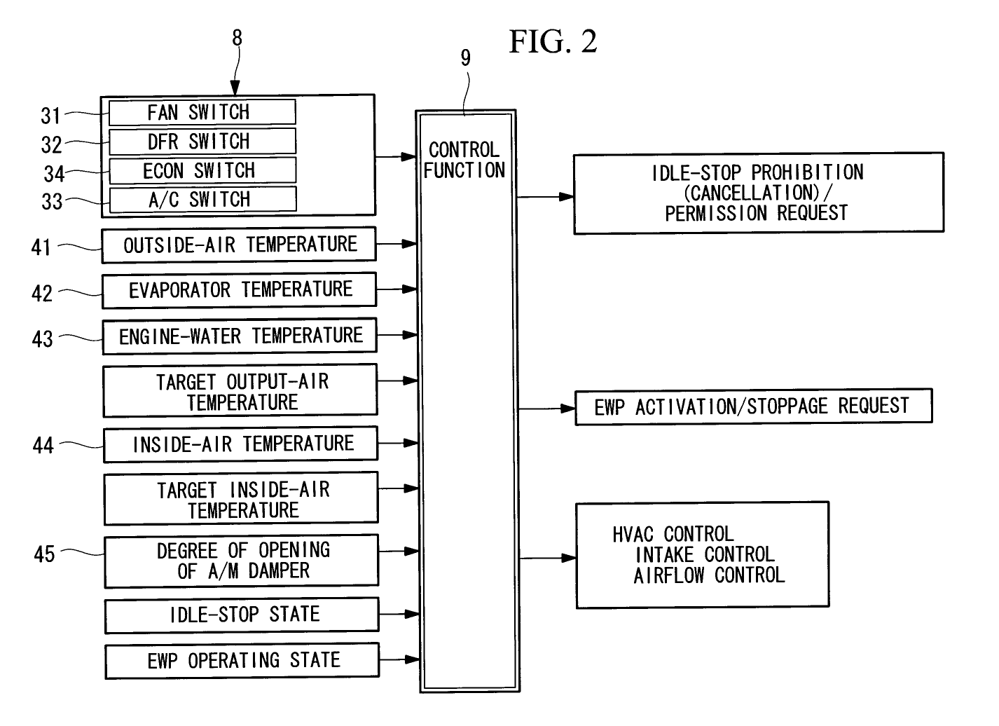

FIG. 2 is a control block diagram in the vehicle air conditioner in FIG. 1.

The input panel 8 is a panel that is provided with a group of various switches related to the control of the vehicle air conditioner 1.

As shown in FIG. 2, the input panel 8 is provided with a fan switch (referred to as “FAN switch” hereinafter) 31 for giving an instruction to rotate or stop the fan 21, a defrost switch (referred to as “DFR switch” hereinafter) 32 for giving an instruction to start or stop a defrosting operation, an air-conditioning switch (referred to as “A/C switch” hereinafter) 33 for giving an instruction to start or stop a cooling operation or a heating operation in the vehicle air conditioner 1, and an economy switch (referred to as “ECON switch” hereinafter) 34 for giving an instruction to start or stop an energy-saving operation related to the vehicle air conditioner 1.

As shown in FIG. 2, the control unit 9 outputs a control signal to, for example, the engine 2 and the HVAC unit 7 on the basis of a signal received from the input panel 8.

As shown in FIGS. 1 and 2, the control unit 9 receives an outside-air temperature measured by an outside-air temperature sensor (detecting unit) 41, an evaporator temperature measured by an evaporator temperature sensor (detecting unit) 42, an engine-water temperature, that is, a coolant temperature, measured by an engine-water temperature sensor (detecting unit) 43, a target output-air temperature, an inside-air temperature measured by an inside-air temperature sensor (detecting unit) 44, the degree of opening of the A/M-damper detected by an A/M-damper degree-of-opening sensor (detecting unit) 45, and inputs related to, for example, an idle-stop state and an EWP operating state from the ECU 11.

As shown in FIG. 1, the outside-air temperature sensor 41 is a temperature sensor disposed in the vicinity of the outside-cabin-air intake 28 in the HVAC unit 7, and the evaporator temperature sensor 42 is a temperature sensor disposed at the evaporator 6. The engine-water temperature sensor 43 is a temperature sensor disposed in the coolant channel 13, and the inside-air temperature sensor 44 is a temperature sensor disposed within the vehicle cabin. The AIM-damper degree-of-opening sensor 45 is a degree-of-opening sensor disposed at the A/M damper 23.

On the other hand, the control unit 9 outputs an IS prohibition request, an IS cancellation request, and an IS permission request to the ECU 11, outputs an EWP activation request and an EWP stop request to the EWP 14, and outputs intake control and airflow control signals to the HVAC unit 7. A detailed control method performed in the control unit 9 will be described later.

The operation of the vehicle air conditioner 1 having the above-described configuration will now be described.

First, the cooling and heating operations performed in the vehicle air conditioner 1 will be described. The cooling operation performed by the vehicle air conditioner 1 of the present embodiment is as follows.

As shown in FIG. 1, the compressor 3 uses the driving force supplied from the engine 2 to take in and compress the refrigerant evaporated at the evaporator 6, and then discharges the refrigerant towards the condenser 4.

The discharged high-temperature high-pressure refrigerant flows into the condenser 4 and radiates heat to the outside cabin air so as to become condensed. The condensed refrigerant flows toward the expansion valve 5 from the condenser 4. The refrigerant flowing into the expansion valve 5 is expanded by the expansion valve 5 so as to become decompressed. The decompressed refrigerant flows toward the evaporator 6 from the expansion valve 5.

The refrigerant flowing into the evaporator 6 absorbs heat from air flowing into the HVAC unit 7 so as to be evaporated. The evaporated refrigerant is taken in by the compressor again, and the above steps are repeated.

In the HVAC unit 7, the fan 21 is rotationally driven so that the outside cabin air and the inside cabin air are taken into the HVAC unit 7 through the outside-cabin-air intake 28 and the inside-cabin-air intake 27 in accordance with the degree of opening of the intake damper 22. The air flowing into the HVAC unit 7, which includes the outside cabin air and the inside cabin air, is cooled as a result of having heat taken away by the refrigerant as the air passes through the evaporator 6.

The cooled air is guided to an outlet 29 by the A/M damper 23 and is blown into the vehicle cabin through the outlet 29.

At the time of the cooling operation, the A/M damper 23 is rotated to a position for guiding the cooled air to the outlet 29. In other words, the A/M damper 23 is rotated to a position where it blocks a flow path of air passing through the heater core 12.

On the other hand, at the time of the heating operation, the EWP 14 sends out the coolant for the engine 2 during the IS mode so as to cause the coolant to circulate between the engine 2 and the heater core 12. The coolant flowing into the heater core 12 from the engine 2 releases heat to the air flowing into the HVAC unit 7 and then flows into the engine 2 again.

In the HVAC unit 7, the A/M damper 23 is rotated to a position for guiding air that has passed through the evaporator 6 towards the heater core 12. In other words, the A/M damper 23 is rotated to a position where it opens the flow path of air passing through the heater core 12.

Therefore, the air passed through the evaporator 6 is subsequently heated as a result of absorbing heat from the coolant when passing through the heater core 12. The heated air is guided to the outlet 29 and is blown into the vehicle cabin through the outlet 29.

With regard to controlling the degree of opening of each of the dampers during the cooling and heating operations and controlling the operation of the compressor 3 and the EWP 14, a known technology can be used, though the technology to be used is not limited in particular.

Idling control of the engine, which is a characteristic feature of this embodiment, will now be described.

The control unit 9 defines, by calculation, an IS prohibition request, an IS permission request, and an IS cancellation request to be output to the ECU 11 of the engine 2 on the basis of a control function to be described below.

First, a threshold to be used for the calculation is selected from a threshold A and a threshold B on the basis of a combination of inputs to the FAN switch 31, the A/C switch 33, and the ECON switch 34 of the input panel 8 (inputting step).

Here, the threshold A is a threshold related to an energy-saving priority mode in which an improvement in fuel consumption is prioritized, whereas the threshold B is a threshold related to an air-conditioning priority mode in which air conditioning in the vehicle cabin is prioritized. These thresholds A and B will be described in detail later.

The relationship between the combination of the FAN switch 31, the A/C switch 33, and the ECON switch 34 and the threshold selected on the basis of the combination is shown in Table 1 below.

TABLE 1

SWITCHING
OPERATION

| CASE | FAN | A/C | ECON | THRESHOLD |
|---|---|---|---|---|
| CASE 1 | ON | ON | ON | A |
| CASE 2 | ON | ON | OFF | B |
| CASE 3 | ON | OFF | ON | A |
| CASE 4 | ON | OFF | OFF | B |
| CASE 5 | OFF | — | — | PERMIT |

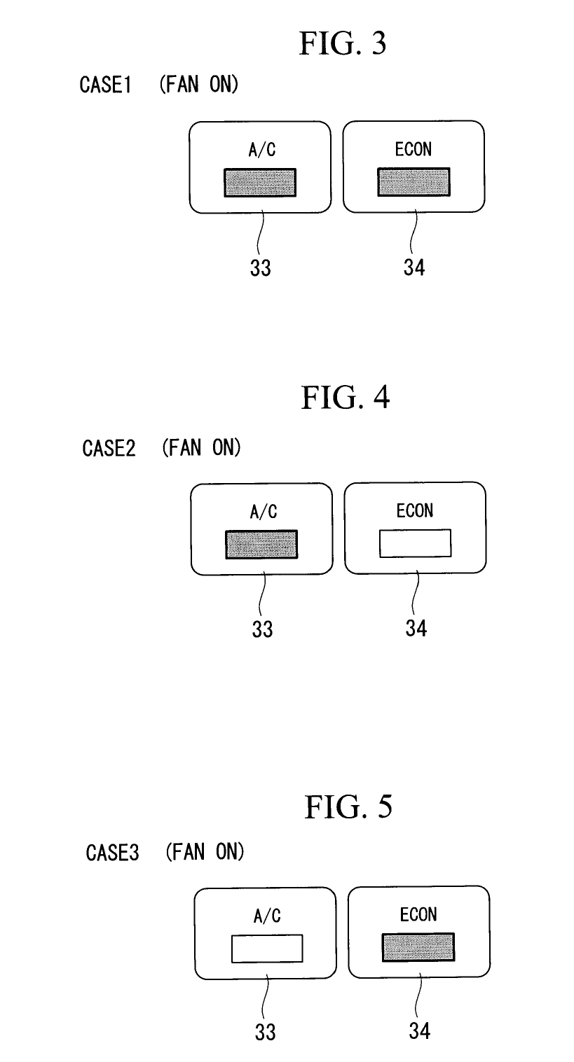

FIG. 3 to FIG. 7 are diagrams illustrating the input status of the switches in CASE 1 to CASE 5 in Table 1. In FIG. 3 to FIG. 7, a shaded switch indicates that the switch is in an ON state, whereas an unfilled switch indicates that the switch is in an OFF state.

In the case where the FAN switch 31, the A/C switch 33, and the ECON switch 34 are all in an ON state (CASE 1), the control function of the control unit 9 selects the threshold A as the threshold.

Similarly, in the case where the FAN switch 31 and the A/C switch 33 are in an ON state but the ECON switch 34 is in an OFF state (CASE 2), the control function of the control unit 9 selects the threshold B as the threshold.

In the case where the FAN switch 31 and the ECON switch 34 are in an ON state but the A/C switch 33 is in an OFF state (CASE 3), the control function of the control unit 9 selects the threshold A as the threshold.

In the case where the FAN switch 31 is in an ON state but the A/C switch 33 and the ECON switch 34 are in an OFF state (CASE 4), the control function of the control unit 9 selects the threshold B as the threshold.

In the case where the FAN switch 31 is in an OFF state (CASE 5), the control unit 9 unconditionally outputs an IS permission request to the engine 2.

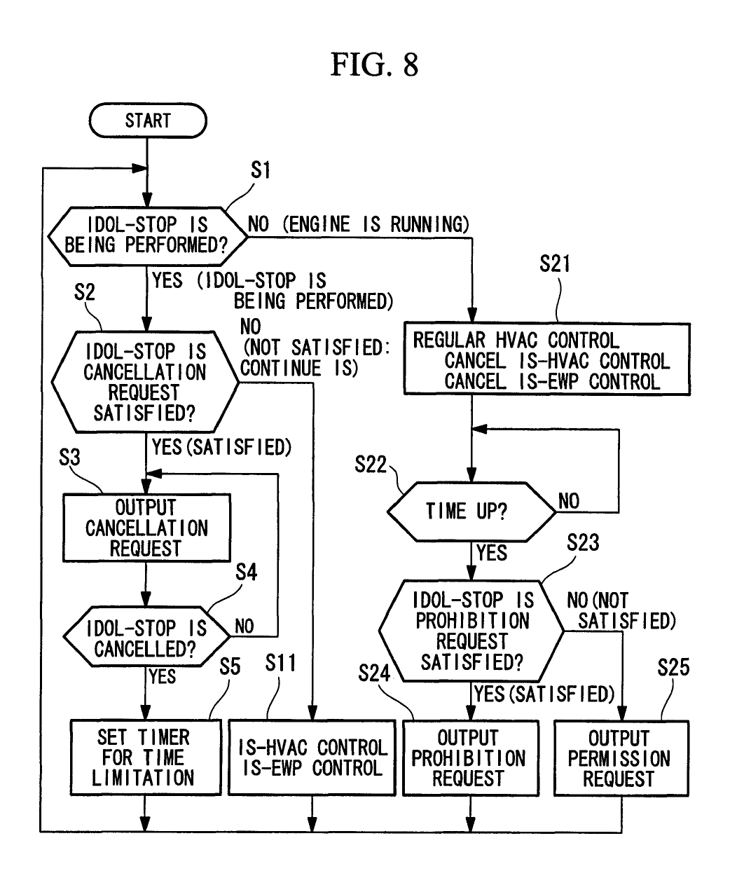

FIG. 8 is a flow chart illustrating the flow of IS control performed by the control unit 9.

Subsequently, the control unit 9 repetitively performs the IS control in accordance with the flow chart shown in FIG. 8 (controlling step).

First, the control unit 9 determines whether or not the engine 2 is performing IS, or in other words, has stopped operating (step S1).

If it is determined that the engine 2 is performing IS, it is determined whether or not an IS cancellation condition to be described below, i.e., a condition for starting the operation of the engine 2, is satisfied (step S2).

If the IS cancellation condition is satisfied, the control unit 9 outputs an IS cancellation request to the ECU 11 of the engine 2 (step S3) and then determines whether or not the IS is actually cancelled (step S4).

If it is determined that the IS is not cancelled, the operation returns to step S3 where the IS cancellation request is output to the ECU 11 again. These steps are repeated until the IS is cancelled.

When it is determined that the IS is cancelled, a timer is set such that the operation enters a standby mode for a predetermined period of time, for example, about 10 seconds (step S5). When the predetermined time elapses (time up), the operation returns to step S1.

On the other hand, if it is determined in step S2 that the IS cancellation condition is not satisfied, or in other words, if it is determined to continue the IS, IS-HVAC control and IS-EWP control, to be described later, are performed (step S11), and the operation returns to step S1.

Furthermore, when it is determined in step S1 that the IS is not being performed, namely, that the engine 2 is running, regular HVAC control is performed. In other words, the above-mentioned IS-HVAC control and IS-EWP control are cancelled (step S21).

Here, regular HVAC control refers to known HVAC control used in the case where the compressor 3 is driven by the engine 2, and is not limited in particular.

Subsequently, similar to step S5, the timer is set such that the operation enters a standby mode for a predetermined period of time, for example, about 10 seconds (step S22).

When it is determined that the predetermined time has elapsed and that the time is up, it is determined whether or not an IS prohibition condition, to be described later, is satisfied (step S23).

If it is determined that the IS prohibition condition is satisfied, an IS prohibition request is output to the engine 2 (step S24), and the operation returns to step S1.

On the other hand, if it is determined that the IS prohibition condition is not satisfied, the IS permission request is output to the engine 2 (step S25), and the operation returns to step S1.

The IS permission request is an output related to stopping of idling of the engine 2 when operating under the IS mode. On the other hand, the IS prohibition request is an output related to a prohibition against stopping the operation of the engine 2 that is idling, or in other words, an output related to the continuance of the idling. An IS cancellation request is an output related to starting of idling of the engine 2 when in a stopped state.

The IS prohibition condition determined in the aforementioned step S23 will be described below.

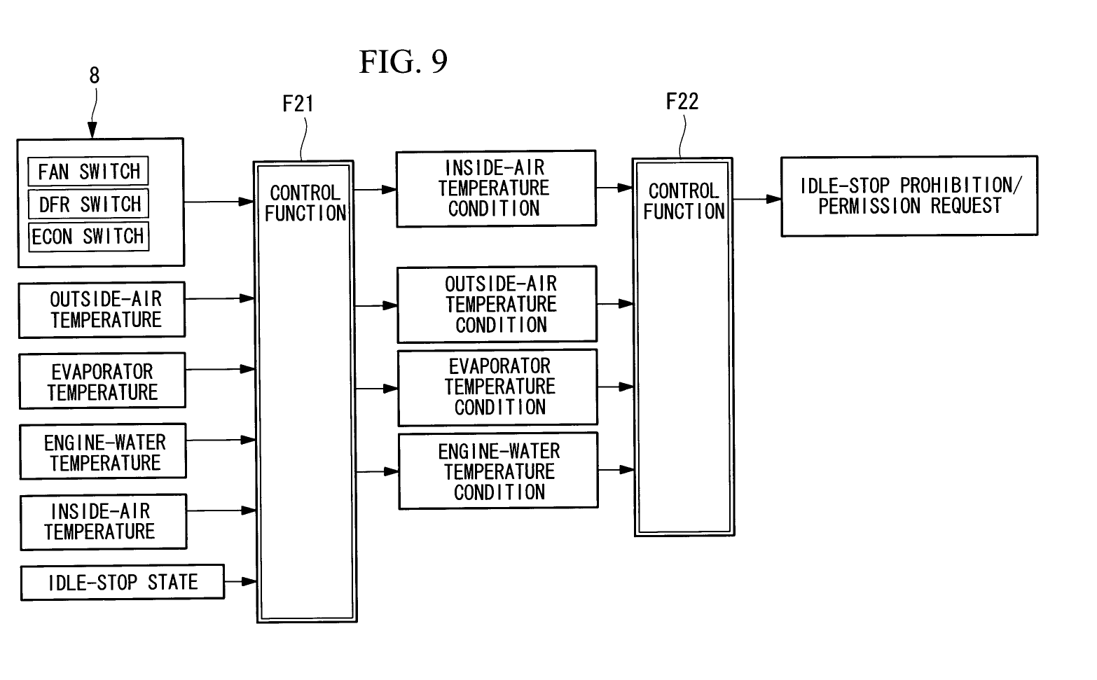

FIG. 9 is a control block diagram used when determining the IS prohibition condition.

As shown in FIG. 9, the control unit 9 has a control function F21 for calculating, on the basis of various control parameters, a prohibition condition related to the inside-air temperature, a prohibition condition related to the outside-air temperature, a prohibition condition related to the evaporator temperature, and a prohibition condition related to the engine-water temperature, to be described below, and also has a control function F22 for determining whether to output the IS prohibition request or the IS permission request.

Control parameters to be received by the control function F21 include selection information about the FAN switch 31, the DFR switch 32, and the ECON switch 34 from the input panel 8, the outside-air temperature measured by the outside-air temperature sensor 41, the evaporator temperature measured by the evaporator temperature sensor 42, the engine-water temperature measured by the engine-water temperature sensor 43, and the inside-air temperature measured by the inside-air temperature sensor 44.

Moreover, an idle-stop state of the engine 2 is also received as a control parameter from, for example, the ECU 11.

The control function F21 outputs to the control function F22 the prohibition condition related to the inside-air temperature, the prohibition condition related to the outside-air temperature, the prohibition condition related to the evaporator, and the prohibition condition related to the engine-water temperature, which are calculated on the basis of the various received control parameters.

Methods for calculating the prohibition condition related to the inside-air temperature, the prohibition condition related to the outside-air temperature, the prohibition condition related to the evaporator, and the prohibition condition related to the engine-water temperature will be described below.

The prohibition condition related to the inside-air temperature is expressed by the following expression (1):

TAISH≧TA≧TAIS (1)

Here, TA denotes an inside-air temperature, and TAISC denotes a lower limit temperature at the higher temperature side of the prohibition condition and is calculated using an expression (2) or an expression (3) below. TAISH denotes an upper limit temperature at the lower temperature side of the prohibition condition and is calculated using an expression (4) or an expression (5) below.

TAISC is calculated in the control unit 9 on the basis of the expression (2) or the expression (3). The expression (2) is an expression used when the aforementioned threshold A is selected, whereas the expression (3) is an expression used when the aforementioned threshold B is selected.

TAISC=TSET+(TAISCa−25)+0.2(20−TO) (2)

TAISC=TSET+(TAISCb−25)+0.2(20−TO) (3)

On the other hand, TAISH is calculated in the control unit 9 on the basis of the expression (4) and the expression (5). The expression (4) is an expression used when the aforementioned threshold A is selected, whereas the expression (5) is an expression used when the aforementioned threshold B is selected.

TAISH=TSET+(TAISHa−25)+0.2(20−TO) (4)

TAISH=TSET+(TAISHb−25)+0.2(20−TO) (5)

Here, TSET denotes a temperature corresponding to an inside cabin temperature that acts as a control target, namely, a set temperature, and TO denotes an outside-air temperature. TAISCa, TAISHa, TAISCb, and TAISHb are thresholds shown in the following table. In this embodiment, the unit of temperature is always degrees Celsius (° C.) unless otherwise noted.

TABLE 2

| | | PARAMETER | | |
|---|---|---|---|---|
| ITEM | | NAME | THRESHOLD | HYSTERESIS |
| LOWER-LIMIT | THRESHOLD A | TAISCa | +32° C. | 2° C. (30° C.) |
| INSIDE-AIR | THRESHOLD B | TAISCb | +28° C. | 2° C. (26° C.) |
| TEMPERATURE AT | | | | |
| HIGHER | | | | |
| TEMPERATURE SIDE | | | | |
| UPPER-LIMIT | THRESHOLD A | TAISHa | +18° C. | 2° C. (20° C.) |
| INSIDE-AIR | THRESHOLD B | TAISHb | +22° C. | 2° C. (24° C.) |
| TEMPERATURE AT | | | | |
| LOWER | | | | |
| TEMPERATURE SIDE | | | | |

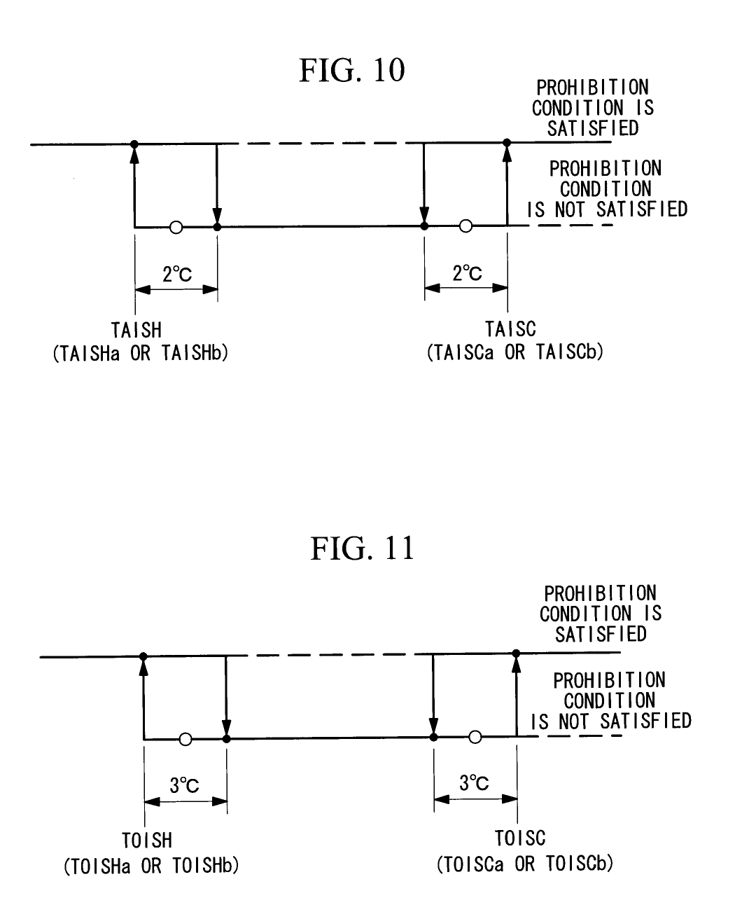

FIG. 10 is a schematic diagram illustrating the prohibition condition related to the inside-air temperature.

In FIG. 10, the upper part indicates a range in which the prohibition condition related to the inside-air temperature is satisfied, whereas the lower part indicates a range in which the prohibition condition related to the inside-air temperature is not satisfied. The horizontal direction in FIG. 10 corresponds to the temperature, and the temperature is shown such that it becomes higher towards the right side.

In FIG. 10, a range in which the aforementioned expression (1) is satisfied, that is, a range in which the IS prohibition request is output, is indicated by a solid line at the upper part, whereas a range in which the expression (1) is not satisfied, that is, a range in which the IS prohibition request is not output, is indicated by a solid line at the lower part.

When the threshold A is selected, that is, when TAISC and TAISH are calculated using TAISCa and TAISHa, respectively, on the basis of the expression (2) and the expression (3), the range in which the aforementioned expression (1) is satisfied becomes wider. On the other hand, when the threshold B is selected, that is, when TAISC and TAISH are calculated using TAISCb and TAISHb, respectively, on the basis of the expression (4) and the expression (5), the range in which the aforementioned expression (1) is satisfied becomes narrower.

The black dots (•) in FIG. 10 each indicate the range belonged to at a boundary point, and the white dots (∘) each indicate an initial value in a hysteresis range.

For example, the black dot corresponding to TAISCa indicates that it belongs to the range in which the expression (1) is not satisfied (upper part), whereas the black dot corresponding to TAISCb indicates that it belongs to the range in which the expression (1) is satisfied (lower part).

Furthermore, the white dot corresponding to TAISC indicates that the range in which the expression (1) is satisfied (lower part) is applied in the case where the vehicle air conditioner 1 is activated when the inside-air temperature is between 28° C. and 32° C.

By using the expressions (2) and (3) or the expressions (4) and (5), namely, by calculating TAISC and TAISH using expressions that include TSET whose set value can be adjusted by the user, a control operation can be performed on the basis of a temperature desired by the user.

Moreover, by calculating TAISC and TAISH while taking into account the effect of the outside-air temperature TO, more comfortable cabin-temperature control can be performed.

The prohibition condition related to the outside-air temperature is expressed by the following expression (6):

TOISH≧TO≧TOISC (6)

Here, TO denotes an outside-air temperature, and TOISC denotes a lower limit temperature at the higher temperature side of the prohibition condition and is a value corresponding to TOISCa or TOISCb shown in the following table. TOISH denotes an upper limit temperature at the lower temperature side of the prohibition condition and is a value corresponding to TOISHa or TOISHb shown in the following table.

TABLE 3

| | | PARAMETER | | |
|---|---|---|---|---|
| ITEM | | NAME | THRESHOLD | HYSTERESIS |
| LOWER-LIMIT | THRESHOLD A | TOISCa | +35° C. | 3° C. (32° C.) |
| OUTSIDE-AIR | THRESHOLD B | TOISCb | +30° C. | 3° C. (27° C.) |
| TEMPERATURE AT | | | | |
| HIGHER | | | | |
| TEMPERATURE SIDE | | | | |
| UPPER-LIMIT | THRESHOLD A | TOISHa | −10° C. | 3° C. (−7° C.) |
| OUTSIDE-AIR | THRESHOLD B | TOISHb | +0° C. | 3° C. (+3° C.) |
| TEMPERATURE AT | | | | |
| LOWER | | | | |
| TEMPERATURE SIDE | | | | |

FIG. 11 is a schematic diagram illustrating the prohibition condition related to the outside-air temperature.

In FIG. 11, the upper part indicates a range in which the prohibition condition related to the outside-air temperature is satisfied, whereas the lower part indicates a range in which the prohibition condition related to the outside-air temperature is not satisfied.

In FIG. 11, a range in which the aforementioned expression (6) is satisfied, that is, a range in which the IS prohibition request is output, is indicated by a solid line at the upper part, whereas a range in which the expression (6) is not satisfied, that is, a range in which the IS prohibition request is not output, is indicated by a solid line at the lower part.

When the threshold A is selected, that is, when TOISCa and TOISHa are used as TOISC and TOISH, respectively, on the basis of the above table, the range in which the aforementioned expression (6) is satisfied becomes wider. On the other hand, when the threshold B is selected, that is, when TOISCb and TOISHb are used as TOISC and TOISH, respectively, on the basis of the above table, the range in which the aforementioned expression (6) is satisfied becomes narrower.

The prohibition condition related to the evaporator is expressed by the following expression (7):

TE2≦TE (7)

Here, TE denotes an evaporator temperature, and TE2 denotes a value corresponding to TE2a or TE2b shown in the following table.

TABLE 4

| | | PARAMETER | | |
|---|---|---|---|---|
| ITEM | | NAME | THRESHOLD | HYSTERESIS |
| EVAPORATOR | THRESHOLD A | TE2a | +5° C. | 10° C. |
| TEMPERATURE | | | | (15° C.: TE1a) |
| | THRESHOLD B | TE2b | +3° C. | 7° C. |
| | | | | (10° C.: TE1b) |

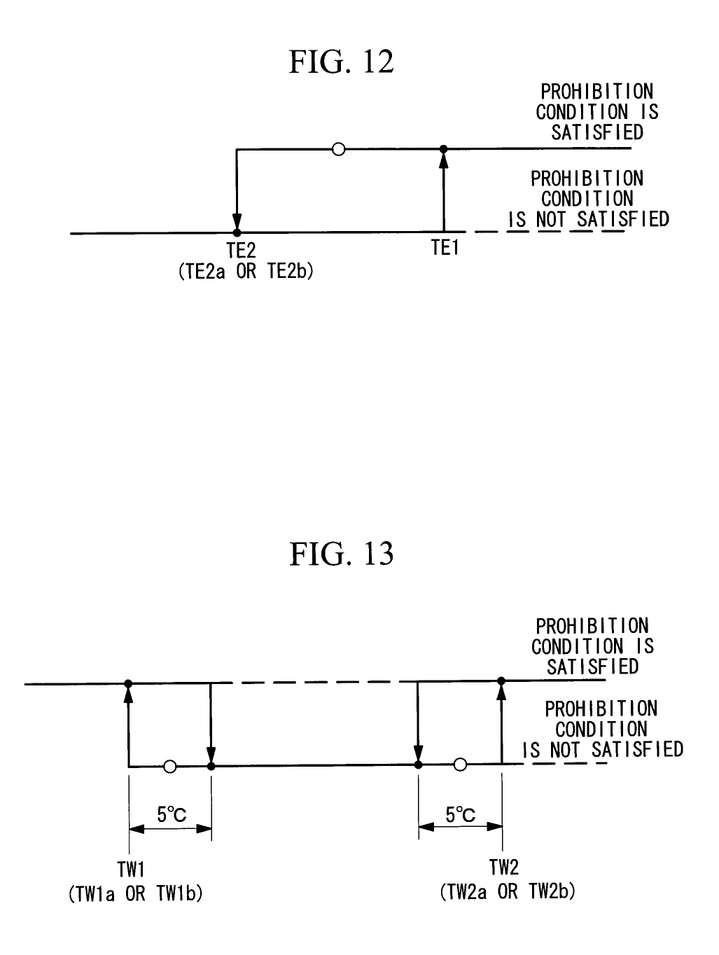

FIG. 12 is a schematic diagram illustrating the prohibition condition related to the evaporator temperature.

In FIG. 12, the upper part indicates a range in which the prohibition condition related to the evaporator temperature is satisfied, whereas the lower part indicates a range in which the prohibition condition related to the evaporator temperature is not satisfied.

In FIG. 12, a range in which the aforementioned expression (7) is satisfied, that is, a range in which the IS prohibition request is output, is indicated by a solid line at the upper part, whereas a range in which the expression (7) is not satisfied, that is, a range in which the IS prohibition request is not output, is indicated by a solid line at the lower part.

When the threshold A is selected, that is, when TE2a is used as TE2 on the basis of the above table, the range in which the aforementioned expression (7) is satisfied becomes narrower. On the other hand, when the threshold B is selected, that is, when TE2b is used as TE2 on the basis of the above table, the range in which the aforementioned expression (7) is satisfied becomes wider.

A value of TE1 in FIG. 12 will be described later in a description of a cancellation condition related to the evaporator temperature.

The prohibition condition related to the engine-water temperature is expressed by the following expression (8):

TW1≧TW≧TW2 (8)

Here, TW denotes an engine-water temperature, and TW1 denotes an upper limit temperature at the lower temperature side of the prohibition condition and is a value corresponding to TW1a or TW1b shown in the following table. TW2 denotes a lower limit temperature at the higher temperature side of the prohibition condition and is a value corresponding to TW2a or TW2b shown in the following table.

TABLE 5

| | | PARAMETER | | |
|---|---|---|---|---|
| ITEM | | NAME | THRESHOLD | HYSTERESIS |
| UPPER-LIMIT | THRESHOLD A | TW1a | +60° C. | 5° C. |
| ENGINE-WATER | | | | (65° C.) |
| TEMPERATURE AT | THRESHOLD B | TW1b | +75° C. | 5° C. |
| LOWER | | | | (80° C.) |
| TEMPERATURE SIDE | | | | |
| LOWER-LIMIT | THRESHOLD A | TW2a | +105° C. | 5° C. |
| ENGINE-WATER | | | | (100° C.) |
| TEMPERATURE AT | THRESHOLD B | TW2b | +105° C. | 5° C. |
| HIGHER | | | | (100° C.) |
| TEMPERATURE SIDE | | | | |

FIG. 13 is a schematic diagram illustrating the prohibition condition related to the engine-water temperature.

In FIG. 13, the upper part indicates a range in which the prohibition condition related to the engine-water temperature is satisfied, whereas the lower part indicates a range in which the prohibition condition related to the engine-water temperature is not satisfied.

In FIG. 13, a range in which the aforementioned expression (8) is satisfied, that is, a range in which the IS prohibition request is output, is indicated by a solid line at the upper part, whereas a range in which the expression (8) is not satisfied, that is, a range in which the IS prohibition request is not output, is indicated by a solid line at the lower part.

When the threshold A is selected, that is, when TW1a and TW2a are used as TW1 and TW2, respectively, on the basis of the above table, the range in which the aforementioned expression (8) is satisfied becomes wider. On the other hand, when the threshold B is selected, that is, when TW1b and TW2b are used as TW1 and TW2, respectively, on the basis of the above table, the range in which the aforementioned expression (8) is satisfied becomes narrower.

The control function F22 determines whether or not the inside-air temperature TA satisfies the aforementioned expression (1), whether or not the outside-air temperature TO satisfies the aforementioned expression (6), whether or not the evaporator temperature TE satisfies the aforementioned expression (7), and whether or not the engine-water temperature TW satisfies the aforementioned expression (8).

Furthermore, the control function F22 determines whether or not the DFR switch 32 is in an ON state.

When any of the aforementioned expressions (1), and (6) to (8) is satisfied or when the DFR switch 32 is in an ON state, the control function F22 outputs the IS prohibition request to the engine 2 only if IS is not performed, that is, if the engine 2 is running and if the FAN switch 31 is ON. But in other cases, the IS permission request is output to the engine 2.

In other words, if a combination described in any of (A) to (E) below is satisfied, the control function F22 outputs the IS prohibition request to the engine 2. In other cases, the control function F22 outputs the IS permission request to the engine 2.
(A) The prohibition condition related to the inside-air temperature is satisfied, IS is not performed, and the FAN switch 31 is ON.
(B) The prohibition condition related to the outside-air temperature is satisfied, IS is not performed, and the FAN switch 31 is ON.
(C) The prohibition condition related to the evaporator temperature is satisfied, IS is not performed, and the FAN switch 31 is ON.
(D) The prohibition condition related to the engine-water temperature is satisfied, IS is not performed, and the FAN switch 31 is ON.
(E) The DFR switch 32 is ON, IS is not performed, and the FAN switch 31 is ON.

As described above, the IS permission request is output on the basis of an absolute value of a control parameter such as the inside-air temperature TA, whereby the timing for outputting the IS permission request can be appropriately controlled.

The IS cancellation condition determined in the aforementioned step S2 will now be described.

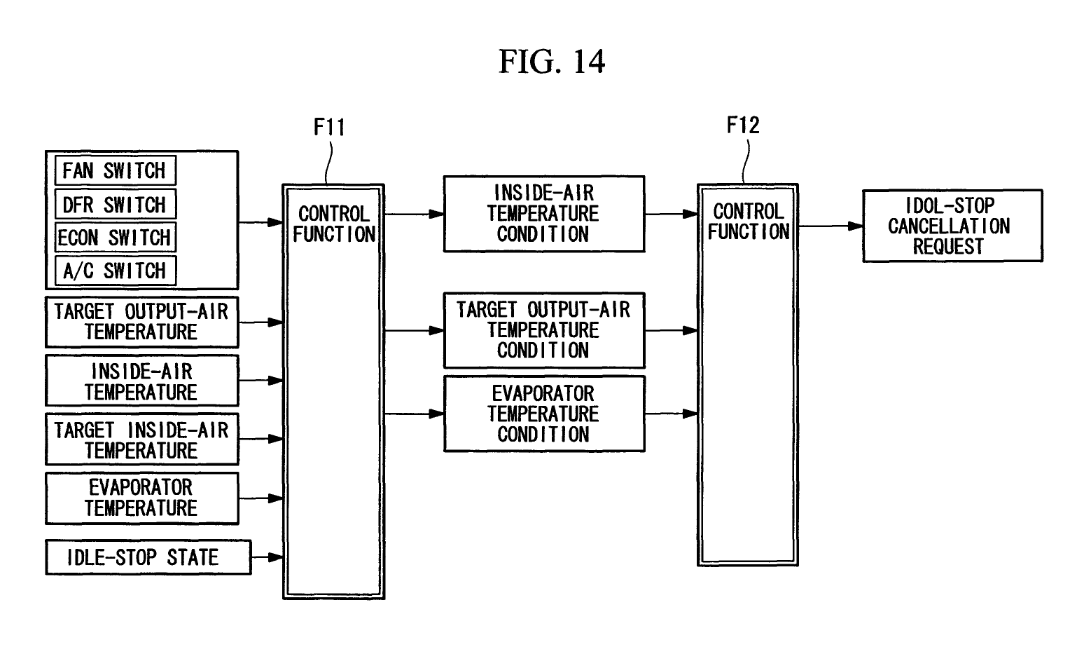

FIG. 14 illustrates a control block used when determining the IS cancellation condition.

As shown in FIG. 14, the control unit 9 has a control function F11 for calculating, on the basis of various control parameters, a cancellation condition related to a target output-air temperature deviation, a cancellation condition related to an inside-air temperature deviation, and a cancellation condition related to the evaporator temperature to be described below, and also has a control function F12 for determining whether to output the IS cancellation request.

Control parameters to be received by the control function F11 include selection information about the FAN switch 31, the DFR switch 32, the ECON switch 34, and the A/C switch 33 from the input panel 8, the target output-air temperature, the inside-air temperature measured by the inside-air temperature sensor 44, and the evaporator temperature measured by the evaporator temperature sensor 42.

Moreover, an idle-stop state of the engine 2 is also received as a control parameter from, for example, the ECU 11.

The control function F11 outputs to the control function F12 the cancellation condition related to the target output-air temperature deviation, the cancellation condition related to the inside-air temperature deviation, and the cancellation condition related to the evaporator temperature, which are calculated on the basis of the various received control parameters.

Methods for calculating the cancellation condition related to the target output-air temperature deviation, the cancellation condition related to the inside-air temperature deviation, and the cancellation condition related to the evaporator temperature will be described below.

The cancellation condition related to the target output-air temperature deviation is expressed by the following expression (9):

TAOHD≧TAOS−TAO≧TAOCD (9)

Here, TAO denotes a target output-air temperature, and TAOS denotes a target output-air temperature when starting IS. Furthermore, TAOHD denotes a lower limit temperature at the higher temperature side of the cancellation condition and is a value corresponding to TAOCDa or TAOCDb shown in the following table. TAOHD denotes an upper limit temperature at the lower temperature side of the cancellation condition and is a value corresponding to TAOHDa or TAOHDb in the following table.

TABLE 6

| | | PARAMETER | | |
|---|---|---|---|---|
| ITEM | | NAME | THRESHOLD | HYSTERESIS |
| UPPER-LIMIT | THRESHOLD A | TAOHDa | −4° C. | 1° C. (−3° C.) |
| TARGET OUTPUT- | THRESHOLD B | TAOHDb | −2° C. | 1° C. (−1° C.) |
| AIR TEMPERATURE | | | | |
| DEVIATION AT | | | | |
| LOWER | | | | |
| TEMPERATURE SIDE | | | | |
| LOWER-LIMIT | THRESHOLD A | TAOCDa | +4° C. | 1° C. (3° C.) |
| TARGET OUTPUT- | THRESHOLD B | TAOCDb | +2° C. | 1° C. (1° C.) |
| AIR TEMPERATURE | | | | |
| DEVIATION AT | | | | |
| HIGHER | | | | |
| TEMPERATURE SIDE | | | | |

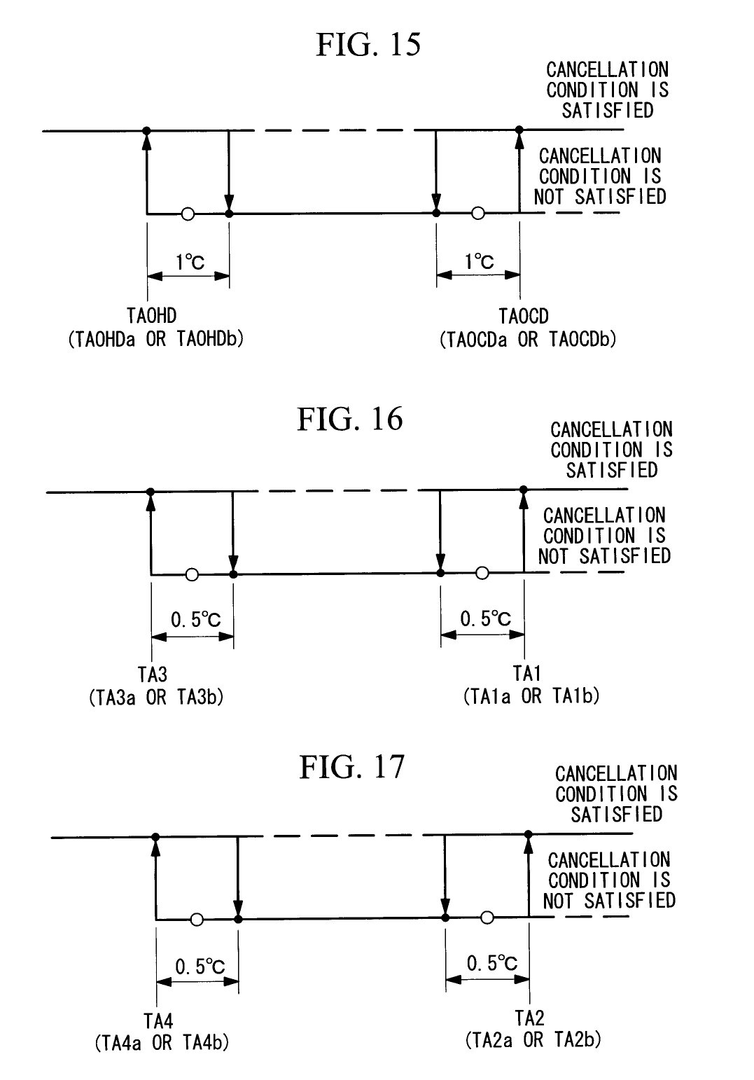

FIG. 15 is a schematic diagram illustrating the cancellation condition related to the target output-air temperature deviation.

In FIG. 15, the upper part indicates a range in which the cancellation condition related to the target output-air temperature deviation is satisfied, whereas the lower part indicates a range in which the cancellation condition related to the target output-air temperature deviation is not satisfied.

In FIG. 15, a range in which the aforementioned expression (9) is satisfied, that is, a range in which the IS cancellation request is output, is indicated by a solid line at the upper part, whereas a range in which the expression (9) is not satisfied, that is, a range in which the IS cancellation request is not output, is indicated by a solid line at the lower part.

When the threshold A is selected, that is, when TAOCDa and TAOHDa are used as TAOCD and TAOHD, respectively, on the basis of the above table, the range in which the aforementioned expression (9) is satisfied becomes wider. On the other hand, when the threshold B is selected, that is, when TAOCDb and TAOHDb are used as TAOCD and TAOHD, respectively, on the basis of the above table, the range in which the aforementioned expression (9) is satisfied becomes narrower.

The cancellation condition related to the inside-air temperature deviation includes a cancellation condition related to a target inside-air temperature deviation expressed by the following expression (10), and a cancellation condition related to an inside-air temperature deviation expressed by the following expression (11):

TA3≧TAMS−TAM≧TA1 (10)

TA4≧TAS−TA≧TA2 (11)

TAM in the expression (10) denotes a target inside-air temperature, and TAMS denotes a target inside-air temperature when starting IS. Furthermore, TA1 denotes a lower limit at the (+) side of the cancellation condition and is a value corresponding to TA1a or TA1b shown in the following table. TA3 denotes an upper limit at the (−) side of the cancellation condition and is a value corresponding to TA3a or TA3b shown in the following table.

On the other hand, TA in the expression (11) denotes an inside-air temperature, and TAS denotes an inside-air temperature when starting IS. Furthermore, TA2 denotes a lower limit at the (+) side of the cancellation condition and is a value corresponding to TA2a or TA2b shown in the following table. TA4 denotes an upper limit at the (−) side of the cancellation condition and is a value corresponding to TA4a or TA4b shown in the following table.

TABLE 7

| | | PARAMETER | | |
|---|---|---|---|---|
| ITEM | | NAME | THRESHOLD | HYSTERESIS |
| LOWER-LIMIT | THRESHOLD A | TA1a | +2° C. | 0.5° C. |
| TARGET INSIDE- | | | | (1.5° C.) |
| AIR TEMPERATURE | THRESHOLD B | TA1b | +1° C. | 0.5° C. |
| DEVIATION AT | | | | (0.5° C.) |
| (+) SIDE | | | | |
| LOWER-LIMIT | THRESHOLD A | TA2a | +3° C. | 0.5° C. |
| INSIDE-AIR | | | | (2.5° C.) |
| TEMPERATURE | THRESHOLD B | TA2b | +1° C. | 0.5° C. |
| DEVIATION AT | | | | (1.5° C.) |
| (+) SIDE | | | | |
| UPPER-LIMIT | THRESHOLD A | TA3a | −2° C. | 0.5° C. |
| TARGET INSIDE- | | | | (−1.5° C.) |
| AIR TEMPERATURE | THRESHOLD B | TA3b | −1° C. | 0.5° C. |
| DEVIATION AT (−) | | | | (−0.5° C.) |
| SIDE | | | | |
| UPPER-LIMIT | THRESHOLD A | TA4a | −3° C. | 0.5° C. |
| INSIDE-AIR | | | | (−2.5° C.) |
| TEMPERATURE | THRESHOLD B | TA4b | −1° C. | 0.5° C. |
| DEVIATION AT (−) | | | | (−0.5° C.) |
| SIDE | | | | |

FIG. 16 is a schematic diagram illustrating the cancellation condition related to the target inside-air temperature deviation.

In FIG. 16, the upper part indicates a range in which the cancellation condition related to the target inside-air temperature deviation is satisfied, whereas the lower part indicates a range in which the cancellation condition related to the target inside-air temperature deviation is not satisfied.

In FIG. 16, a range in which the aforementioned expression (10) is satisfied, that is, a range in which the IS cancellation request is output, is indicated by a solid line at the upper part, whereas a range in which the expression (10) is not satisfied, that is, a range in which the IS cancellation request is not output, is indicated by a solid line at the lower part.

When the threshold A is selected, that is, when TA1a and TA3a are used as TA1 and TA3, respectively, on the basis of the above table, the range in which the aforementioned expression (10) is satisfied becomes wider. On the other hand, when the threshold B is selected, that is, when TA1b and TA3b are used as TA1 and TA3, respectively, on the basis of the above table, the range in which the aforementioned expression (10) is satisfied becomes narrower.

FIG. 17 is a schematic diagram illustrating the cancellation condition related to the inside-air temperature deviation.

In FIG. 17, the upper part indicates a range in which the cancellation condition related to the inside-air temperature deviation is satisfied, whereas the lower part indicates a range in which the cancellation condition related to the inside-air temperature deviation is not satisfied.

In FIG. 17, a range in which the aforementioned expression (11) is satisfied, that is, a range in which the IS cancellation request is output, is indicated by a solid line at the upper part, whereas a range in which the expression (11) is not satisfied, that is, a range in which the IS cancellation request is not output, is indicated by a solid line at the lower part.

When the threshold A is selected, that is, when TA2a and TA4a are used as TA2 and TA4, respectively, on the basis of the above table, the range in which the aforementioned expression (11) is satisfied becomes wider. On the other hand, when the threshold B is selected, that is, when TA2b and TA4b are used as TA2 and TA4, respectively, on the basis of the above table, the range in which the aforementioned expression (11) is satisfied becomes narrower.

The cancellation condition related to the evaporator temperature is expressed by the following expression (12):

TE≧TE1 (12)

Here, TE denotes an evaporator temperature, and TE1 denotes a value corresponding to TE1a or TE1b shown in the following table.

TABLE 8

| | | PARAMETER | | |
|---|---|---|---|---|
| ITEM | | NAME | THRESHOLD | HYSTERESIS |
| EVAPORATOR | THRESHOLD A | TE1a | +15° C. | 10° C. |
| TEMPERATURE | | | | (5° C.: TE2a) |
| | THRESHOLD B | TE1b | +10° C. | 7° C. |
| | | | | (3° C.: TE2b) |

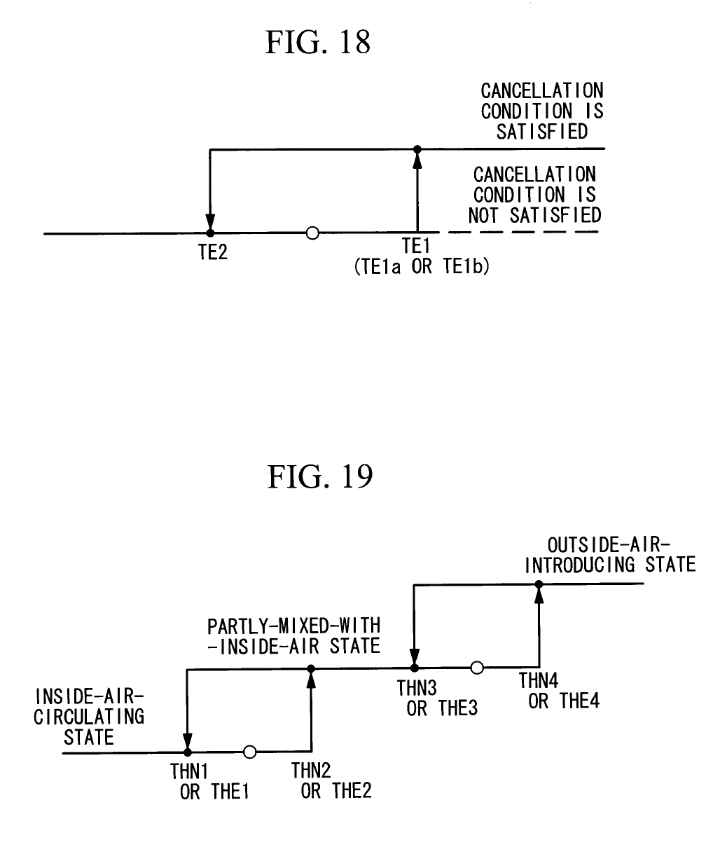

FIG. 18 is a schematic diagram illustrating the cancellation condition related to the evaporator temperature.

In FIG. 18, the upper part indicates a range in which the cancellation condition related to the evaporator temperature is satisfied, whereas the lower part indicates a range in which the cancellation condition related to the evaporator temperature is not satisfied.

In FIG. 18, a range in which the aforementioned expression (12) is satisfied, that is, a range in which the IS cancellation request is output, is indicated by a solid line at the upper part, whereas a range in which the expression (12) is not satisfied, that is, a range in which the IS cancellation request is not output, is indicated by a solid line at the lower part.

When the threshold A is selected, that is, when TE1a is used as TE1 on the basis of the above table, the range in which the aforementioned expression (12) is satisfied becomes wider. On the other hand, when the threshold B is selected, that is, when TE1b is used as TE1 on the basis of the above table, the range in which the aforementioned expression (12) is satisfied becomes narrower.

A value of TE2 in FIG. 18 is described above in the description of the prohibition condition related to the evaporator.

The control function F12 determines whether or not the target output-air temperature deviation (TAOS−TAO) satisfies the aforementioned expression (9), whether or not the target inside-air temperature deviation (TAMS−TAM) satisfies the aforementioned expression (10), whether or not the inside-air temperature deviation (TAS−TA) satisfies the aforementioned expression (11), and whether or not the evaporator temperature TE satisfies the aforementioned expression (12).

Furthermore, the control function F12 determines whether or not the DFR switch 32 is in an ON state.

When any of the aforementioned expressions (9) to (12) is satisfied or when the DFR switch 32 is in an ON state, the control function F12 outputs the IS cancellation request to the engine 2 only if IS is being performed, that is, if the engine 2 is stopped, and if the FAN switch 31 is ON. On the other hand, if the aforementioned conditions are not satisfied, the IS permission request is continuously output. For example, even when IS is being performed, the IS cancellation request is not output to the engine 2 if the FAN switch 31 is OFF.

In other words, if a combination described in any of (F) to (J) below is satisfied, the control function F12 outputs the IS cancellation request to the engine 2.
(F) The cancellation condition related to the target output-air temperature deviation is satisfied, IS is being performed, and the FAN switch 31 is ON.
(G) The cancellation condition related to the target inside-air temperature deviation is satisfied, IS is being performed, and the FAN switch 31 is ON.
(H) The cancellation condition related to the inside-air temperature deviation is satisfied, IS is being performed, and the FAN switch 31 is ON.
(I) The cancellation condition related to the evaporator temperature is satisfied, IS is being performed, and the FAN switch 31 is ON.
(J) The DFR switch 32 is ON, IS is being performed, and the FAN switch 31 is ON.

As described above, the IS prohibition request or cancellation request is output on the basis of an amount of change in a control parameter such as the target output-air temperature deviation, whereby the timing for outputting the IS prohibition request or cancellation request can be appropriately controlled.

The IS-HVAC control and the IS-EWP control performed in the aforementioned step S11 will now be described.

The IS-HVAC control will be described first. The IS-HVAC control includes intake control for controlling switching between outside air and inside air to be taken into the HVAC unit 7, and airflow control for controlling the volume of air to be blown from the HVAC unit 7.

FIG. 19 is a schematic diagram illustrating the intake control when the ECON switch is OFF or ON.

As shown in FIG. 1, the intake control includes controlling the intake damper 22 of the HVAC unit 7 so as to control the flow rate of the inside cabin air and the outside cabin air flowing into the HVAC unit 7.

In the intake control, different control is performed depending on whether the ECON switch 34 is ON or OFF. As shown in FIG. 19, when the ECON switch 34 is OFF, regular control, namely, the same control as that when IS is not performed, is carried out.

In FIG. 19, the upper part indicates an outside-air-introducing state, the middle part indicates a state where the outside air is partly mixed with inside air, and the lower part indicates an inside-air-circulating state. The horizontal direction in FIG. 19 corresponds to a target temperature (target output-air temperature) of air to be output from the HVAC unit 7, and the temperature is shown such that it becomes higher towards the right side.

When the ECON switch 34 is OFF, regular control is performed.

In this case, a target temperature, i.e., a threshold, when switching from one state to another state includes a switching threshold THN1 of 0° C. for switching from the partly-mixed-with-inside-air state to the inside-air-circulating state, a switching threshold THN2 of 5° C. for switching from the inside-air-circulating state to the partly-mixed-with-inside-air state, a switching threshold THN3 of 10° C. for switching from the outside-air-introducing state to the partly-mixed-with-inside-air state, and a switching threshold THN4 of 15° C. for switching from the partly-mixed-with-inside-air state to the outside-air-introducing state, as shown in FIG. 19.

On the other hand, when the ECON switch 34 is ON, the threshold for switching from one state, such as the inside-air-circulating state, to another state is adjusted so as to broaden an inside-air mode range in a cooling region.

In this case, a target temperature, i.e., a threshold, when switching from one state to another state includes a switching threshold THE1 of 5° C. for switching from the partly-mixed-with-inside-air state to the inside-air-circulating state, a switching threshold THE2 of 10° C. for switching from the inside-air-circulating state to the partly-mixed-with-inside-air state, a switching threshold THE3 of 15° C. for switching from the outside-air-introducing state to the partly-mixed-with-inside-air state, and a switching threshold THE4 of 20° C. for switching from the partly-mixed-with-inside-air state to the outside-air-introducing state, as shown in FIG. 19.

When the ECON switch 34 is ON as described above, the thresholds for switching from one state, such as the inside-air-circulating state, to another state may be uniformly adjusted, or two kinds of thresholds A and B may be used as described below. In other words, it is not particularly limited.

When the threshold A is selected, a switching threshold THE1a for switching from the partly-mixed-with-inside-air state to the inside-air-circulating state is set at 10° C., a switching threshold THE2a for switching from the inside-air-circulating state to the partly-mixed-with-inside-air state is set at 15° C., a switching threshold THE3a for switching from the outside-air-introducing state to the partly-mixed-with-inside-air state is set at 20° C., and a switching threshold THE4a for switching from the partly-mixed-with-inside-air state to the outside-air-introducing state is set at 25° C., as shown in the following table.

On the other hand, when the threshold B is selected, a switching threshold THE1b for switching from the partly-mixed-with-inside-air state to the inside-air-circulating state is set at 5° C., a switching threshold THE2b for switching from the inside-air-circulating state to the partly-mixed-with-inside-air state is set at 10° C., a switching threshold THE3b for switching from the outside-air-introducing state to the partly-mixed-with-inside-air state is set at 15° C., and a switching threshold THE4b for switching from the partly-mixed-with-inside-air state to the outside-air-introducing state is set at 20° C., as shown in the following table.

TABLE 9

| | | | | | |
|---|---|---|---|---|---|
| THRESHOLD | THRESHOLD A | THE1a | THE2a | THE3a | THE4a |
| | | +10° C. | +15° C. | +20° C. | +25° C. |
| | THRESHOLD B | THE1b | THE2b | THE3b | THE4b |
| | | +5° C. | +10° C. | +15° C. | +20° C. |

The airflow control will now be described.

When IS is being performed, the control unit 9 controls the operation of the fan 21 on the basis of the following table. By performing this control, a drastic temperature change, especially, a rapid increase in the output-air temperature in the cooling region, can be prevented from occurring, thereby reducing the current consumption in the fan 21.

TABLE 10

| | | COOLING | |
|---|---|---|---|
| ITEM | | REGION | HEATING REGION |
| AIRFLOW | THRESHOLD A | 14/31 LEVEL | 14/31 LEVEL |
| CONTROL | THRESHOLD B | 20/31 LEVEL | 20/31 LEVEL |

The above-described airflow control allows for desired settings for each of the cooling region and the heating region.

The table shown above is applied to the case where the total number of switchable levels is 31, but the number is not limited in particular.

The EWP control will now be described.

The EWP control is performed for circulating the coolant for the engine, i.e., a heat source for heating, even when the engine is stopped (during IS), and is performed by determining whether or not an EWP-ON request condition or an EWP-OFF request condition, to be described below, is satisfied.

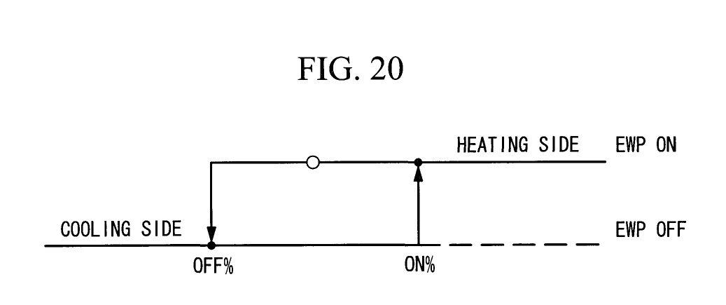

FIG. 20 is a schematic diagram illustrating the EWP control.

The EWP-ON request condition is determined to be satisfied if all of the following conditions are satisfied: IS is being performed, the FAN switch 31 is in an ON state, and the degree of opening of the A/M damper 23 is equal to or above an ON % value (heating side) in the following table (see FIG. 20).

On the other hand, the EWP-OFF request condition is determined to be satisfied if any of the following conditions is satisfied: IS is cancelled, the FAN switch 31 is in an OFF state, and the degree of opening of the A/M damper 23 is equal to or below an OFF % value (cooling side) in the following table (see FIG. 20).

TABLE 11

| ITEM | | OFF % | ON % |
|---|---|---|---|
| EWP OPERATION CONTROL | THRESHOLD A | 10% | 20% |
| | THRESHOLD B | 0% | 10% |

Here, the degree of opening of the A/M damper 23 is 0% at the time of maximum cooling, and 100% at the time of maximum heating.

Furthermore, the threshold A is a threshold used during the energy-saving priority mode and is used when minimizing the performance of the EWP 14 to save power, whereas the threshold B is a threshold used during the air-conditioning priority mode and is used when the engine coolant, i.e., heated water, is to be made to circulate continuously as usual, except at the time of maximum cooling.

According to the above configuration, one of the IS permission request, prohibition request, and cancellation request is output to the engine 2 on the basis of one of the threshold A related to the energy-saving priority mode and the threshold B related to the air-conditioning priority mode, thereby extending the IS period of the engine 2 and increasing the range of energy-saving operation by stopping the engine without impairing the air conditioning comfort.

Specifically, when the energy-saving priority mode is selected, the threshold A related to the energy-saving priority mode is selected. Consequently, the output timing of the IS permission request, etc. is controlled so as to extend the IS period of the engine 2, thus increasing the range of energy-saving operation.

On the other hand, when the air-conditioning priority mode is selected, the threshold B related to the air-conditioning priority mode is selected. Consequently, the output timing of the IS permission request, etc. is controlled so that a driving period of the compressor 3 driven by the engine 2 can be ensured, whereby air conditioning inside the vehicle cabin can be properly performed.

In the case where the IS prohibition request or cancellation request is output and the engine 2 continues or starts idling, as in the aforementioned step S5 or step S22, the IS permission request is not output only after elapse of a predetermined period of time. Therefore, the idling of the engine 2 continues at least for the predetermined time. This prevents the idling of the engine 2 from being stopped and started repetitively at short intervals.

The timing for outputting, for example, the IS permission request to the engine 2 can be controlled more appropriately on the basis of a control parameter related to at least one of the engine 2 and the evaporator 6, e.g., the IS state of the engine 2 or the evaporator temperature.

1. A vehicle air conditioner comprising:
a compressor that is driven by an engine to compress a refrigerant;
a heat radiator that radiates heat from the compressed refrigerant;
an expansion valve that decompresses the refrigerant from which the heat is radiated;
a heat absorber that makes the decompressed refrigerant absorb heat;
an input unit to which selection information about an air-conditioning priority mode and an energy-saving priority mode is input; and
a control unit that selects one of a threshold related to the air-conditioning priority mode and a threshold related to the energy-saving priority mode on the basis of at least the selection information input to the input unit, and outputs one of an idle-stop permission request, an idle-stop prohibition request, and an idle-stop cancellation request to the engine on the basis of the selected threshold.

2. The vehicle air conditioner according to claim 1, further comprising a detecting unit that detects a control parameter related to at least one of the engine and the heat absorber, and
wherein the control unit outputs one of the idle-stop permission request, the idle-stop prohibition request, and the idle-stop cancellation request to the engine on the basis of the selected threshold and the control parameter detected by the detecting unit.

3. The vehicle air conditioner according to claim 2, wherein the control unit outputs the idle-stop permission request to the engine on the basis of an absolute value of the control parameter.

4. The vehicle air conditioner according to claim 2, wherein the control unit outputs the idle-stop prohibition request or the idle-stop cancellation request to the engine on the basis of an amount of change in the control parameter.

5. The vehicle air conditioner according to claim 1, wherein the control unit outputs the idle-stop prohibition request or the idle-stop cancellation request and is then allowed to output the idle-stop permission request only after elapse of a predetermined time.

6. A vehicle air conditioner comprising:
a compressor that is driven by an engine to compress a refrigerant;
a heat radiator that radiates heat from the compressed refrigerant;
an expansion valve that decompresses the refrigerant from which the heat is radiated;
a heat absorber that makes the decompressed refrigerant absorb heat;
a detecting unit that detects a control parameter related to at least one of the engine and the heat absorber; and
a control unit that outputs an idle-stop cancellation request to the engine on the basis of an amount of change in the detected control parameter occurring from an idle-stop starting point.

7. A method for controlling a vehicle air conditioner, comprising:
an inputting step for inputting selection information about an air-conditioning priority mode and an energy-saving priority mode; and
a controlling step for selecting one of a threshold related to the air-conditioning priority mode and a threshold related to the energy-saving priority mode on the basis of at least the selection information and, on the basis of the selected threshold, outputting one of an idle-stop permission request, an idle-stop prohibition request, and an idle-stop cancellation request to an engine that drives a compressor that compresses a refrigerant
